(19) United States
(12) Patent Application Publication
(10) Pub. No.: US 2016/0187889 A1
(43) Pub. Date: Jun. 30, 2016

(54) SYSTEM FOR OPENING AND CLOSING PRESSURIZED FLUIDS

(71) Applicant: Hugo Arturo FLORES LEIJA, Monterrey, Nuevo León (MX)

(72) Inventor: Hugo Arturo FLORES LEIJA, Houston, TX (US)

(21) Appl. No.: 14/910,651

(22) PCT Filed: Jul. 17, 2014
(86) PCT No.: PCT/MX2014/000108

§ 371 Date: Feb. 5, 2016

(30) Foreign Application Priority Data
Aug. 6, 2013 (MX) MX/A/2013/009051

(51) Int. Cl. G05D 7/01

(52) U.S. Cl. CPC G05D 7/0126

(57) ABSTRACT

The present invention comprises of a system of opening and closing for pressurized fluids, that comprises of 3 modules;
a) module of closing and opening,
b) module of resistance to flow, check system;
c) module of release double action, these 3 modules are found interconnected within each other, shaping diverse possible configurations and can be utilized in diverse applications.

### INVENTION OBJECTIVE

Through the present invention, there is an intention to register a system for opening and closing pressurized fluids which compromises basically 3 modules, the module of closing and opening, the module of flow resistance or system check and the module of release double action. The principal objective of this system is to generate a system adaptable and diverse configurations offering numerous and notable advantages with respect to diverse applications characterized by the absence of mechanical elements.

### ANTECEDENT

There exists diverse systems and appliances for fill and pressurized, for diverse applications, maybe the most common is the device for supplies and distribution of water, either in buildings, facilities or hydromantic equipment, even more in diverse systems of discharge tanks trough valves, according to how they are described in continuance.

a) Distributary Valves

In the pneumatic system, compressed air is led to various ways in the start, the stop and the change of sense of movement from the piston inside the cylinder.

Normal closed valve: doesn't allow the passage of air in rest position. If it is put in action it allows compressed air to circulate. Normal open valve=in rest position the passage of air is free and if put in action it closes. Starting position=a movement of the mobile parts of a valve when it is mounted on equipment and feeds the pressure of the pneumatic network. To represent the functions of the distributary valves, symbols that indicate the number of positions and ways the valve functions are utilized.

In the hydraulic system distributary valves or directional controls are utilized to change the sense of flow inside the cylinder and to move the piston from an extreme to the other in its career.

b) Pressure Control Valves

The pressure control valves are used to control the pressure in a system. Even though the pressure control valves have different designs, their function is the same. Some types of pressure control valves are: relief valves, sequence valves, valves that reduce pressure, differential pressure valves and discharge valves.

Relief valves; Hydraulic systems are designed to operate inside a certain scope of pressure. Exceeding this scope can damage the system components or be converted into a potential risk for the user. The relief valve maintains the pressure inside the specific limits and when open it lets the excess fluid flow to another circuit or return to the tank.
Simple pressure relief valve, pressure in the opening of the valve; the simple relief valve (also called motion direct valve) is maintained closed by the motion of the force of the spring. The tension of the spring is adjusted to a “relief pressure”. However, the adjustment of the relief pressure is not the pressure that makes the valve begin opening.
Simple pressure relief valve, adjusting the relief pressure: An increase in the resistance of the flow of oil increases the volume of the excess flow and therefore the pressure of the circuit. The increase of the circuit pressure exceeds the new tension of the spring and makes the relief valve open. The relief valve is simply generally used when the flow volume of oil is in excess or below or an answer is needed fast. This makes the simple relief valve ideal to relieve pressures caused by crashes or as a security valve.
Relief valve from pilot operation, CLOSED position. The relief valve of

Pilot operation is frequently used in systems that require a great volume and where there is a small difference between the pressure of the opening in the valve and the pressure of the full flow. In the relief valve of pilot operation, a pilot valve (simple relief valve) controls the discharge valve (principal valve).
Relief valve from pilot operation, OPEN position when the pressure of the fluid from the system exceeds the value of the spring of the pilot valve, the pilot valve opens and allows the fluid from the chamber of the spring of the discharge valve to flow to the tank. The orifice of the pilot valve is much bigger than the orifice of the discharge valve. Therefore, the fluid will pass faster trough the pilot valve than the orifice of the discharge valve. This will cause the pressure in the chamber the spring of the discharge to diminish.
Sequence valve in OPEN position; when the pressure from the chamber of the spring of the discharge valve exceeds the value of the pilot valve adjustment the pilot valve opens. The open pilot valve allows oil to pass through the chamber of the discharge valve spring to the tank and diminishes the pressure in the chamber spring of the discharge valve. The force of the highest pressure of the fluid moves the discharge valve against the spring of the discharge valve and opens the conduit.
Pressure reducing valve: The pressure reducing valve allows two circuits with different pressure to obtain their supply from the same pump. The relief valve controls the maximum pressure of oil supply. The reducing pressure valve controls the maximum pressure in the oil control circuit.

c) Flow Control Valves

The objective of the flow control is to control the volume of fluid that enters or exits the circuit. The flow control of a hydraulic circuit can be done in various ways. The most common way is placing and orifice in the system. By putting an orifice a major restriction from the normal is produced from the flow of the pump. A major restriction will produce and increase in the pressure of the fluid. The increase of the pressure of the fluid will make part of it flow another path. The path may be trough another circuit or through a relief valve. The three most common factors are;
1. The temperature and pressure of the fluid.
2. The size of the orifice
3. The differential pressure trough the orifice d) Blockage Valves

These valves are useful in blocking the passage of fluid, 4 types of blockage valves can be distinguishes: backstop, simultaneous, selective and escape.
Backstop valves: blocks the tail of the flow in one direction of passage leaving free the circulation of the flow in the opposite direction.
The backstop valve is operated by a pilot, it acts by applying pilot pressure lifting the ball to allow the passage of the fluid in one direction. If the pilot pressure is not applied the valve acts like a normal backstop valve.
Simultaneous valve: The simultaneous valve opens the passage towards an exit when pressure is applied in the openings. If different pressure is applied in both openings, the signal whom has the most pressure will go to the exit.
Selective Valves: It is also called double command backstop valve or backstop double.

e) Escape valve: this type of valve has two functions to do. One to release fluid as fast as possible, because since the fluid has to pass through great quantity of pipes it would take too long to exit. The other function is that sometimes leftover pressure is left in the pipes which facilitates errors in the functionality of the circuit, with this type of valve these errors are prevented.

Inside these systems numerable alternatives are found to achieve the opening and closing of the system or dipositive, through the medium of differential pressure, some trough other mechanic mediums, in the present invention it is intended to present an alternative simple system for closing and opening all types of pressurized fluids, including likely {candidates} for compression, in total absence of mechanic mediums, only utilizing the system to be presented, manipulating the pressure differential presented in the device that is intended to be protected in the present. For this present document is serves to reference patent NL/a/2004/000008 titled Pressure device for sanitariums which is the patent granted at the moment, which functions at the base of the difference of pressures, only that said patent is focused solely on sanitariums however, this new system counts with different systems and at the industrial level, functions utilizing the same medium, coupled with other elements or interconnected modules in itself, thus interacting with the same device of double mechanical action revelation in said patent.

### DESCRIPTION OF THE FIGURES

FIG. #1 represents the armory and transversal view of the Opening and Closing Module in configuration 1 of opening and closing against the flow, where the diaphragm is observed.

In FIG. #2 the armory and transversal view is shown of the Opening and Closing Module in its configuration 2 of opening and closing in favor of the flow, where it is observed the absence of the diaphragm (7) and in its place just a packaging (8) for the upper closure (9 and 9a)

In FIG. #3 the enlarged view of the opening and closing module for configuration 1 of opening and closing against the flow, where the diaphragm appears (7).

FIG. #4 represents the enlarged view of the closing and opening for configure 2 of opening and closing in favor of the flow, where a packaging is appreciated (8) instead of a diaphragm (7).

FIG. #5 represent the enlarged view of the module resistant to the flow (System check) where all its components are appreciated.

FIG. #6 shows the armored module resistant to the flow (System check).

In FIG. #7 the transversal cut of the resistance flow module is appreciated (System check), where one can visualize the point of reduction in the inside diameter of the body, that is signaled by the number 13 in this figure, and is where the check is positioned (FIG. #8).

In FIG. #8 a detailed drawing of the check element is shown, where the characteristics applicable to the resistance flow module is appreciates and presented in FIG. #7

FIG. #9 shows the enlarged view of the double action revelation module, in which all the components are appreciated. It fits to point out that in this design the slots (26) are along the interior diameter (25) of the body (24) with difference with the revelation valve utilized in the patent NL/a/2004/000008, which has the slots situated longitude way in the piston (31), however, there exists no difference in regards to functionality.

FIG. #10 shows us an armored view of the Release Double Action Module.

In FIG. #11 a view of the transversal section of the Release double action module is presented.

FIG. #12 the check element is shown with its proper characteristics for configuration 3—Opening and Closing of a pressured tank that contains fluids capable of compression.

FIG. #13 shows the fluid diagram for configuration #1—Opening and Closing contra flow.

In FIG. #14 the diagram for flow is presented for configuration #2—Opening and closing in favor of the flow.

FIG. #15 presents the elements in configuration #3—For Opening and Closing of a pressurized tank that contains fluids capable of compression.

In FIG. #16 the positioned elements are shown of configuration #3—For Opening and Closing of a pressurized tank that contains fluids capable of compression, just like the flow diagram for this configuration.

FIG. #17 presents an enlarged view of the closing and opening module for configuration #3 For opening and closing a pressurized tank that contains fluids capable of compression, in addition the view of the armored module is appreciated.

FIG. #18 shows a view of the armored closing and opening module, and a transversal view of configuration #3 for Opening and Closing a pressurized tank that contains fluids capable of compression.

FIG. #19 presents in general form a check element in open position, shows how the check moves in the orifice (67) wall (66). The figure #19b shows in general form the check element in closed position covering the orifice (67) in the wall (66). These figures are presented to more clearly show the present invention, and with the goal to be illustrative but not limited.

### DETAILED DESCRIPTION OF THE INVENTION

The system of opening and closing of pressurized fluids is compromised by three modules which are:
A.—Module of Opening and Closing
B.—Module of Flow Resistance (System Check)
(10) C.—Module of release double action

In accordance with the above, in continuance the 3 modules will be described;

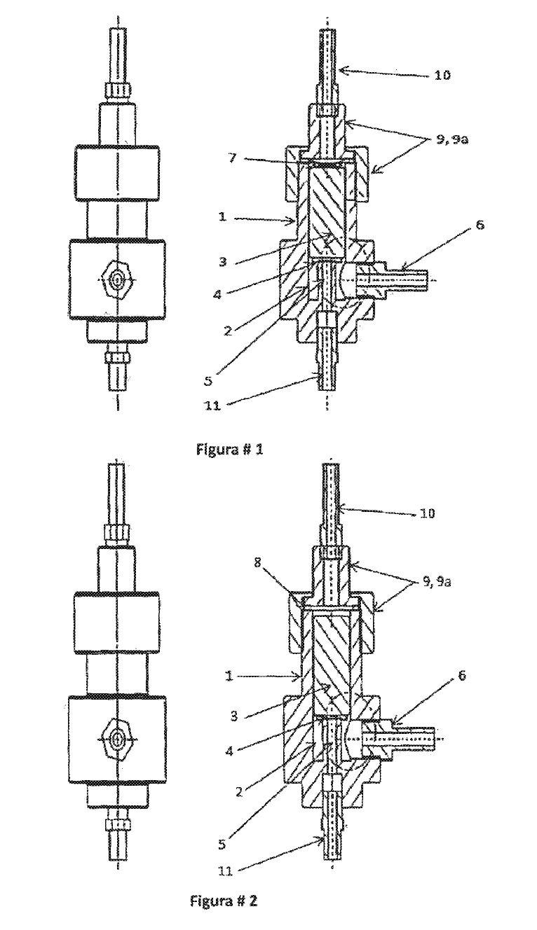

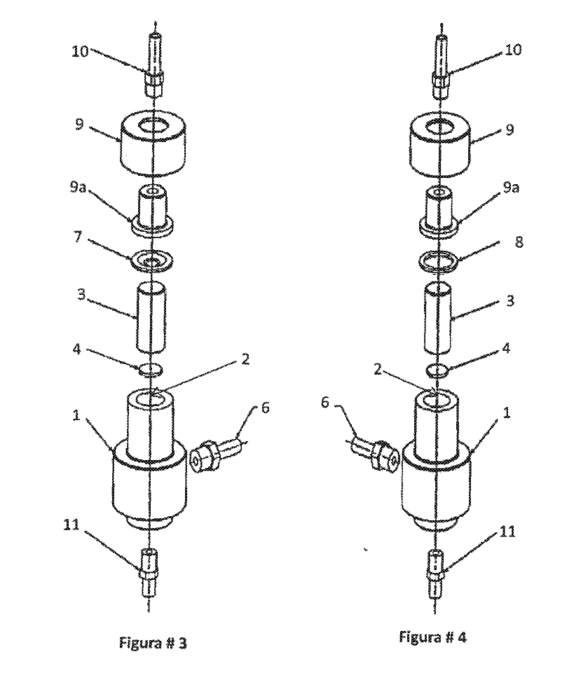

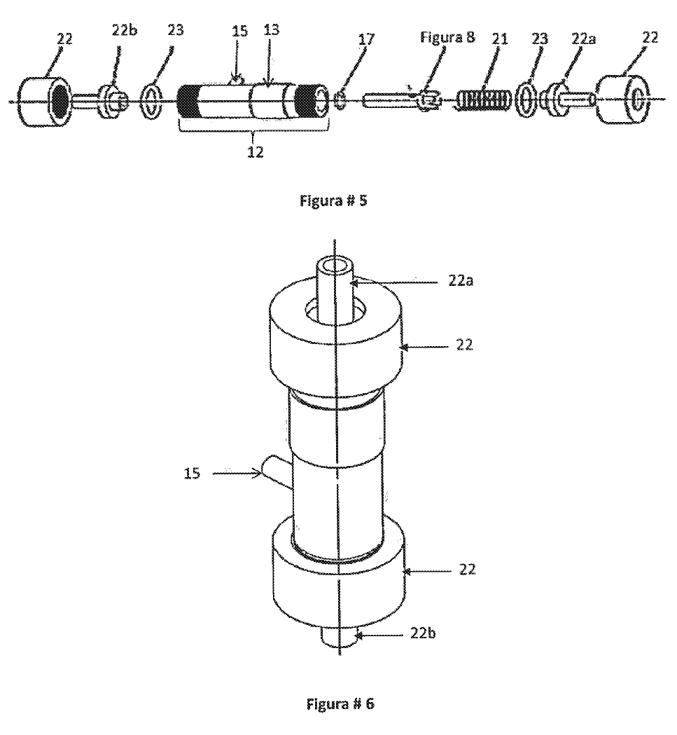

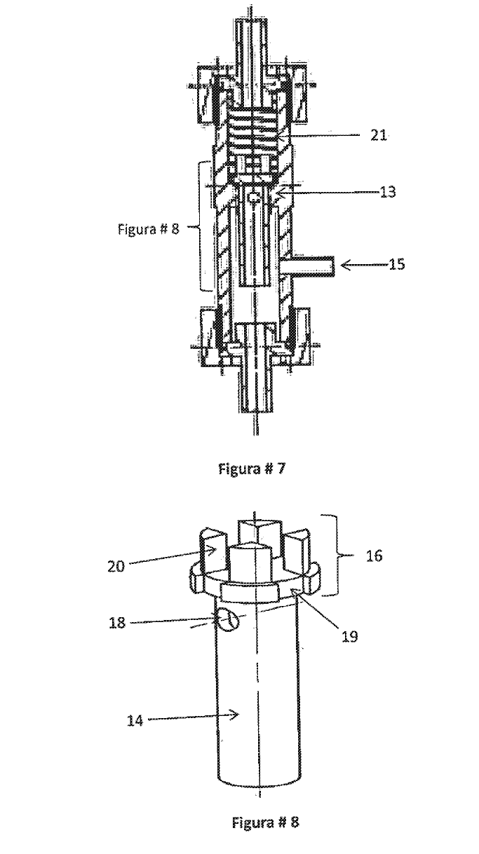

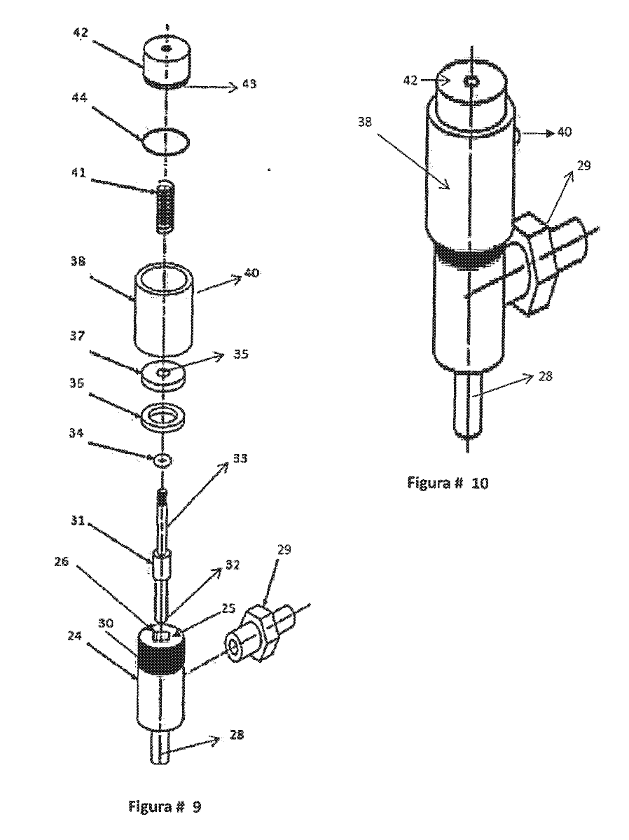

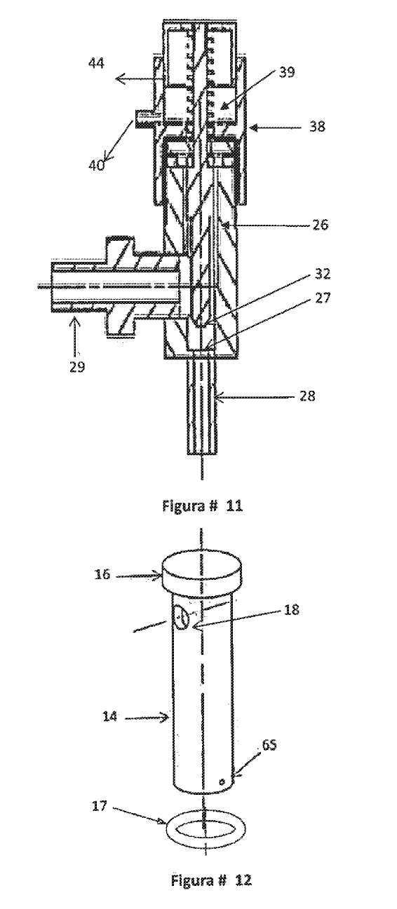

A.1—Module of Opening and Closing for configuration 1 and 2 It consists of a valve body of opening and closing (1) in which presented is a diameter interior (2), from which a piston is displaced (3), in which in its inferior part counts with a package (4) in which the piston is attached (3), said gasket (4) allows seal and closure over a tube (5) that may be of discharge or admission (depending on the configuration), said tube (5) oversees the bottom of the body interior of the valve of closing and opening (1) and its diameter exterior is less than the interior diameter (2) of the body of the closing and opening valve (1), in the inferior part of the body of the closing and opening and closing valve (1) a conduit is situated (6) (which can function as conduit Of admission or discharge, depending on whichever is the case of the configuration), this conduit (6) connects with the interior diameter (2) and is situated in between the bottom interior of the body of the valve (1) and the superior border of the tube (5). The height of the tube (5) should allow that the conduit (6) be placed under the superior border of the tube (5). In the superior part of the (5) body of the valve of closing and opening (1) in the case of configuration 1 of opening and closing contra-flow (FIG. 13) counts with the diaphragm (7), meanwhile in configuration 2 of opening and closing in favor of the flow a ring package is utilized (8). Let it be the usage of the package or diaphragm, these should stay trapped in the superior part of the body of the closing and opening valve (1) and the lid (9, 9a), said lid (9, 9a) (10) allows the impenetrable closure of the superior part of the body of the closing and opening valve (1). This cover (9, 9a) is provided from a central conduit (10). The connection (11) connects with the tube (5), which acts in the manner depending on the configuration. In this module, it serves to highlight that are in the transversal section of the piston (3) must be greater than the transversal area of the tube (5) such that it allows the hydraulic manipulation of the piston (3) trough (15) vectors derived from the same pressure of the fluid.

A.2—Module of closing and opening for configuration 3 with integrated check it is composed of 2 sections, in its inferior part we have a board base (51) in which its superior part is projected in a discharge tube (52), at the same time the inferior part is projected in a threaded section (53) in that same tube (52) to position itself through a package (47) (20) and a nut (48), in the orifice (46) situated at the bottom of a closed tank (45), from the board base (51) tire studs peek out (54) to position the superior section of the module through some nuts (55). The superior section of the module consists of a cylinder (56) that in its superior part has exceeding diameter (57) with 4 orifices (58) to Position through the studs (54) and the nuts (55) completing the structure of the module.

Said cylinder (56) is hollow and is open in the inferior part, counting with a interior diameter (59) all along the inside of the cylinder (56) that is attached. A smaller sized hollow cylinder is intruded (60) open on one of the sides, the open part is put (5) in the inside of the cylinder (56), in the inferior part of the cylinder (60) a package is attached (61), said cylinder (60) comes to be the piston in this configuration that is displaced all along the interior diameter (59) of the cylinder (56) and the reason it has a cup form is with the purpose to give room to execute the check (FIG. #12) inside the same module. The superior part or roof of the cylinder (56) has an orifice (66) which is the means that introduces the (10) tubular bolt (14) from the check (FIG. #12), said bolt counts with the package (17) placing trough the interior part of the cylinder (56) a compression spring (62), a washer (63) and a bolt (64), is left placed in the check like it is appreciated in FIG. #18. In this configuration and in the virtue of the spring (62) is coupled directly over the tubular bolt (14) and requires a washer (63) that contains the spring (62) and a bolt (64) (15) that at its time retains the washer (63), said bolt (64) is placed in the orifice (65) like it is shown in FIG. #12, it is important to highlight that the spring (62) can be contained by any other system of containment. In this configuration the head of the check (16) does not have the cutouts (19), nor the supporting beams (20) in virtue that the head (16) is in an open space. In the superior part or the roof of the hollow cylinder (56) (20) we also have a connection (50) which communicates with the bushings. (49)

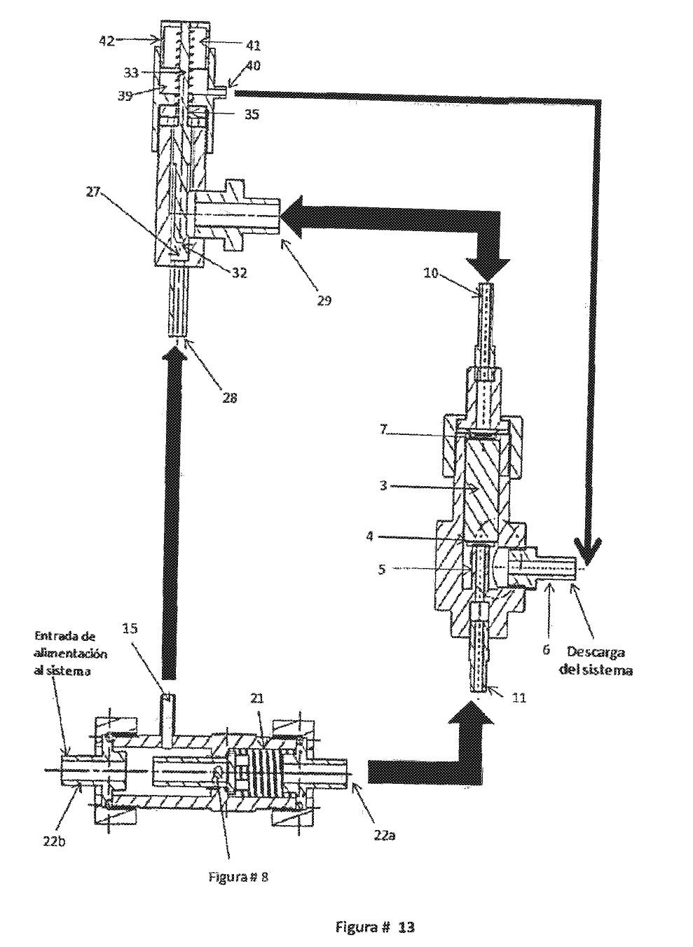

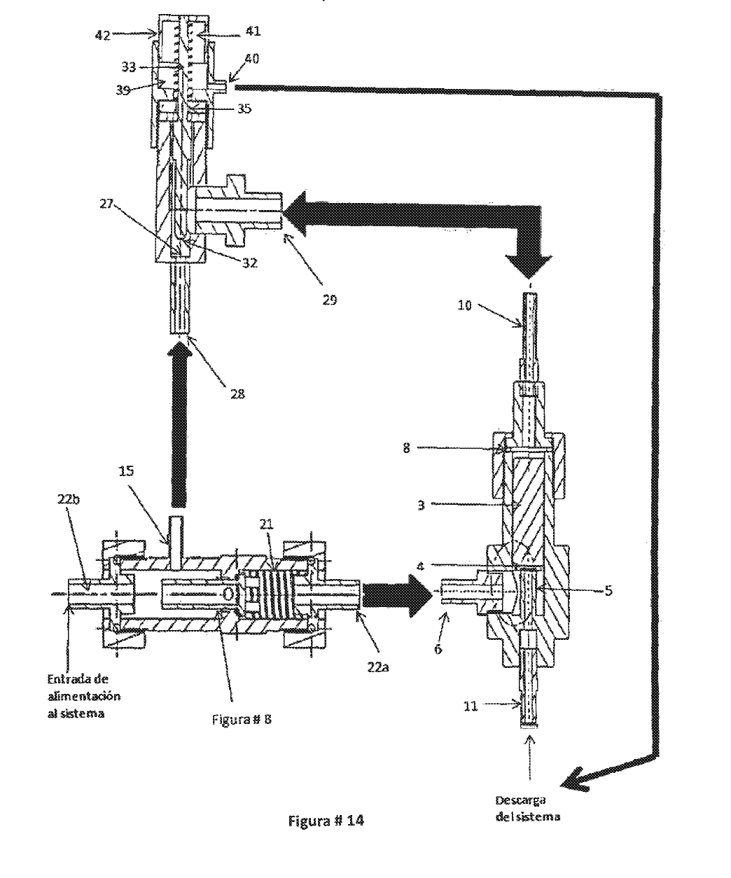

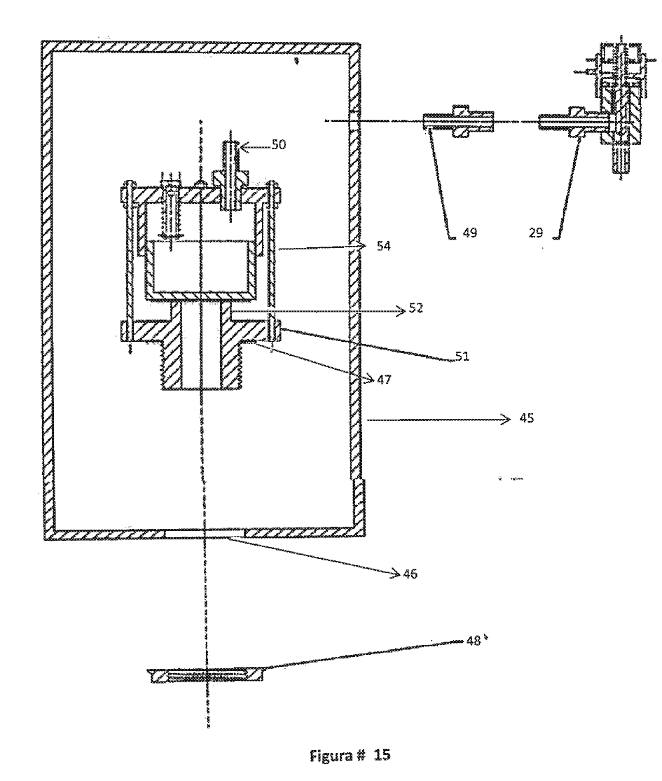

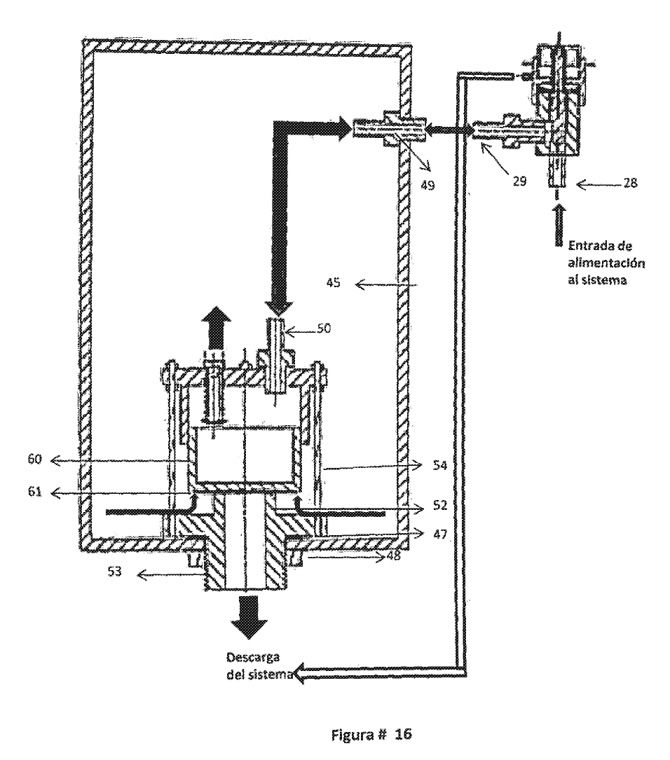

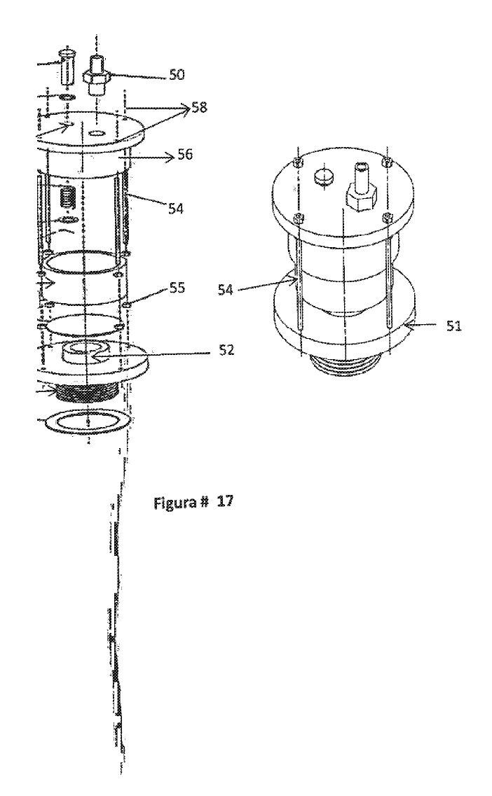

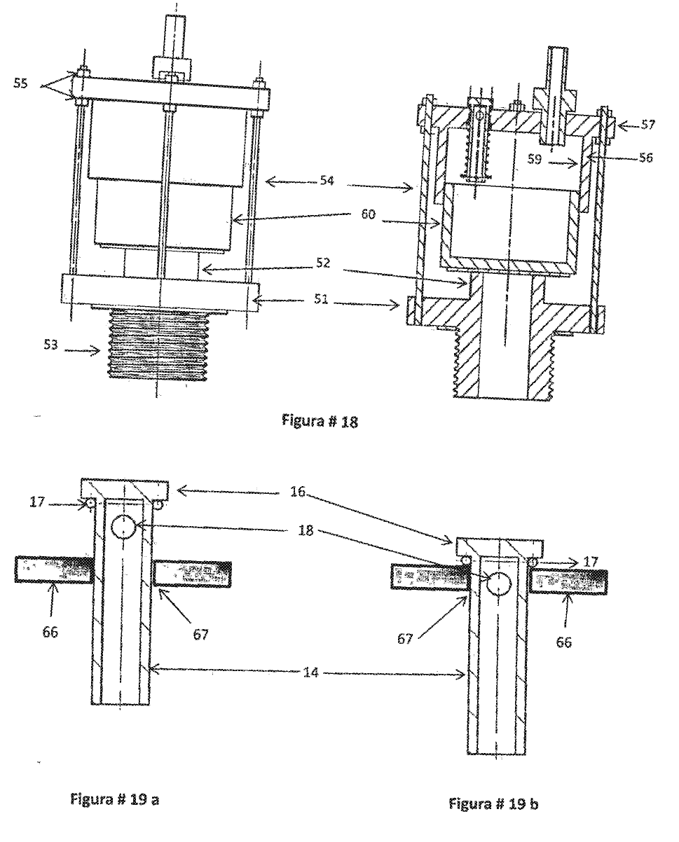

B. 1) Module of Resistance Flow (System Check) for configurations 1 and 2 this module is comprised of a body from the module of resistance flow (12), opened by both sides, said body (12) with an interior diameter that at an intermediary point in between the extremes with the goal of creating a stop (13) for the check (FIG. #18) in a point understood by the stop (13) and in the left extreme a conduit is located (15) perpendicular to the body of the module of flow resistance (12) which communicates with the interior diameter of the same module (12), this conduit (15) will feed the module of (5) release double action. The check (FIG. #18) is a tubular bolt (14) which counts with a head (15) in one of those extremes, it is placed in a type o-ring package (17) (FIG. #5) over said tubular bolt (14), which is positioned to touch with the head (16), the tubular bolt (14) represents perimeter orifices (18) just before the o-ring (17). In respect to the head (16) this counts perimeter with the cutouts (19) that (10) allow the passage of fluid and with supporting beams that peek out (20) that work to position the spring (21), this spring (21) is comprised of one of the lids (22) which counts on a conduit (22a) in conjunction with a package (23) impenetrably close this extreme of the body of the module of flow resistance (12). The closure of the other extreme is through a lid (22) which counts with a conduit (22b) 0 and with an gasket (23) in the (15) in the form to achieve an impenetrable closure on the opposite extreme. The module of flow resistance counts with 2 identical covers in its extremes described previously and both provided from a central conduit (22a, 22b respectively), to be connected in the system. It is important to highlight that the design of the check (FIG. #8 and FIG. #12) is an appropriate design that represents diverse advantages, which are; (20) 1). That the tubular bolt (14) while moving along the orifice (67) of the wall (66) it pretends to block, prevents the sealed element (gasket) from dislocating, guaranteed the correct position of the same (FIG. 19a, FIG. 19b).

2) It is important to highlight that even though the orifice is totally blocked (67) when sealed in the open position as FIG. #19a shows, the fluid passes through the interior diameter in the tubular bolt (14) and is transmitted towards the other side of the wall (66) through the perimeter orifices (18), maintaining an area of constant flow (5) in respect to the interior transversal area of the tubular bolt (14). And in its closed position the orifice where this runs (67), remains blocked by the head (16) and the gasket (17), as demonstrated in FIG. #19b. It is important to mention that the compression spring can be place in the upper part of the head (16) like it is appreciated in FIG. #7 or position it in the same tubular bolt (14) (10) securing with a lock the other extreme of the orifice (67) to cover the wall (66), as shown in FIG. #18.

3) The cutouts (19) in the head of the check (16) allow the maintenance of the area of the flow constant, in case the check (FIG. #8) is hosted in a cylinder container as shown in FIG. #7. The supporting beams that peek through (20) (15) allow the positioning of the compression spring (21) in the manner that when contained with a lid we obtain a check system that will not stray from the correct path, and in its open position, will maintain a flow constant with the function of the interior transversal area of the tubular bolt (14).

B.2) Module of Resistance of Flow (System Check) for configuration 3. This module of resistance flow (system check) is integrated in the module of closing and opening of configuration 3.

C) Module of Release Double Action

This module is comprised of a body of the module of release double action (24) which has a central cavity or interior diameter (25), said cavity benefits from longitude slots (26) longwise, at the bottom of this central cavity or interior diameter (25) (5) a smaller concentric orifice is located (27) that is the entrance of the conduit (28), in the lower part of the body of the module of release double action (24) a conduit is placed (29) perpendicular to that body (24), said conduit (29) communicates the interior diameter (25) with the exterior diameter. Said body of the module of release double action (24) benefits with a threaded section in the superior exterior part (30) a (10) piston (31), is introduced in the central cavity or interior diameter (25) of the body of the module of release double action (24), said piston (31) has in its inferior extreme a conical termination (32) which has the necessary dimensions to cover the concentric orifice (27), in the other extreme, it has a spike with its superior extreme threaded (33) which is coupled with an gasket (34) to seal the orifice (35), serves to (15) mention that the diameter of the spike (33) is less than that of the orifice (35), to let a relief of fluid in the action moment of the de-pressure. This module also has a gasket (36), a cover (37) and a closure element (38), which couples with the superior thread (30) of the body of the module of release double action (24) to close the body of the valve (24). This element of closure (38) in its superior part has a (20) cavity (39) to contain fluids that result from de-pressure.

The closure element (38) has a conduit (40) to conduct the fluids resulting from the discharge. Likewise the spike (33) that peeks out, couples with a spring (41) which Is retained by a nut-bolt (42) that has a groove in its perimeter (43) to accommodate the ring (o-ring) type packaging (44). Once the 3 modules that comprise the System of opening and closing for pressurized fluids is described, it is to be described the functioning of the 3 different configurations (5) that can be armored with these 3 modules. It is important to highlight that the configurations presented are illustrative, but not limiting.

Functioning of Configuration 1—Opening and Closing Against Flow

In configuration 1 of opening and closing against flow, presented in FIG. #13 the fluid is fed to the system of opening and closing for pressurized fluids trough (10) the conduit (22b) of the module of resistance floe, by the conduit a part of the flow is deflected towards the module of release of double action, entering through the medium of conduit (28), and exits the same trough the conduit (29) to deposit the module of closing and opening through the conduit. The pressure of the fluid pushes the diaphragm (7) which in turn pushed the piston (3) with its gasket (4) to the closed position over the tube, (it is important to mention that the module of resistance flow allows the priority of the flow towards the module of release double action and likewise priority exists in the low through the conduit to the superior part of the module of closing and opening to push the piston (3), this module of resistance flow likewise, allows the flow in one single direction through it, the flow will also pass through the check (FIG. #8) when it encounters its position of open, through the conduit (22a) it exists the module of resistance flow to continue to the module of closing and opening trough the conduit (11) that connects the tube when the pressure is left in equilibrium the spring (21) pushes the check (FIG. #8) to its closed position. At this point in the system it will remain closed, as the transversal area of the piston (3) is greater the transversal area of the tube.

Managing the formula for force=pressure×area, we have that the resulting vector is closed, because if we have to:
(5) A=Transversal area of the piston (3)
a=transversal area of the tube (5)
P=existing pressure of the fluid
   Therefore; the resulting vector in that position is the following;

Resulting Vector=P (A)−P (a); which as a result gives a positive vector, that is of closing In the moment that we activate the module of release double action pushing the nut-bolt (42) we provoke that the conical termination (32) closes the orifice (27) and opens an exit to the atmosphere trough the slots (26) passing the fluid trough the space understood between the spike (33) and the orifice (35), the resulting fluid of the de-pressure is accommodated in a cavity (39) to be conducted through the conduit (40) towards the discharge. Once the pressure is relieved, the fluid seizes to exercise pressure over the diaphragm (7) the piston (3) and the gasket (4) provoke that the pressure of the fluid enters through the conduit (11) that communicates with the tube that allows the piston (3) to remain in open position, action that is followed whichever enters the tube is conducted towards the exterior of the system through the conduit (6). At this point the resulting vector is an opening, due to the following.

Resulting vector=P (A)−P (a); in which the pressure of the superior part of the piston (3) is zero, therefore the results would be;

Resulting vector=[−P(a)] this being a negative vector, it's to say, of opening.

At the moment we leave the actions the module of release double action, like was explained before, the piston (3) and its gasket (4) will cover over the tube (5) detaining the fluid towards the exterior.

It is important to highlight that in this configuration it is necessary to utilize a diaphragm or impermeable membrane (7), as the piston (3) runs free trough the interior diameter (2) and does not have a seal with respect to that diameter. Likewise in this configuration (10) specifically, if we did not have said diaphragm or membrane (7) the fluid would pass through the piston (3) and the diameter (2) towards the exit (6). This applies solely to this configuration 1 of opening and closing against flow.

### Functioning of the Configuration 2-Opening and Closing in Favor of the of the Flow

In configuration 2 of opening and closing in favor of the flow, presented in FIG. #14 the fluid is fed to the system of opening and closing for pressurized fluids trough the conduit (22b) of the module of release double action, entering through its conduit (28), and exits the same trough the conduit (29) to enter the module of closing and opening trough the conduit. The pressure of the fluid pushes the piston (3) with its gasket (4) to the position of closure over the tube, (important to mention that the module of flow resistance allows the prioritization of the flow towards the module of release double action and likewise for priority to exist for flow through the conduit to the superior part of the module of closing and opening to push the piston (3), this module of flow resistance likewise, allows the flow in one single direction through it) the fluid also passed through the check (FIG. #8) when it encounters the position of being open, through the conduit (22a) exits the module of flow resistance to continue to the module of closing and opening trough the conduit (6) when the pressure is left in equilibrium the spring (21) pushes the check (FIG. #8) to a closed position.

At this point the system remains in its closed position, under the virtue that the transversal area of the piston (3) is greater than the transversal areas of the tube.

Managing the force formula=pressure×area, we have that the resulting vector is closed,

Because if we have to:
A=Transversal area of the piston (3)
a=transversal area of the tube (5)
P=existing fluid pressure

Therefore; the resulting vector is in the point following;

Resulting Vector=P (A)−P(A−a); that results in a positive vector, that is of closing.

In the moment that we activate the module of release double action pushing the nut-bolt (42) we provoke that the conical termination (32) closes the orifice (27) and opens an exit to the atmosphere trough the slots (26) passing the fluid trough the space (20) understood between the spike (33) and the orifice (35), the resulting fluid of the de-pressure accommodated in a cavity (39) to be conducted through the conduit (40) towards the discharge. Once the pressure is relieved, the fluid seizes to exercise pressure over the piston (3) the and the gasket (4) provoking that the pressure of the fluid enters trough the conduit (6) that allows the piston (3) to remain in open position, action that is followed whichever enters the conduit (6) is conducted towards the exterior of the system through the tube and conduit (11) respectively. At this point the resulting vector is opening due to the following;
Resulting vector=P(A)−P (A−a); in which the superior part of the piston (3) is zero, therefore the result would be;
Resulting vector=[−P(A−a)] this being a negative vector, that is to say, of opening.

During the time to stop the action of the module of release double action, as was explained before, the piston (3) and its gasket (4) close the tube (5) detaining the flow towards the exterior.

This configuration does not require diaphragm or membrane (7) under which the exit remains perfectly sealed by the gasket (4).

Assemble for Configuration #3—For Opening and Closing a Pressurized Tank that Contains Fluids Susceptible to Compression

Configuration #3, is shown in FIGS. #15 and 16, which consists of a closed tank (45) whose bottom has an orifice (46), in which positioned is the module of opening and closing for this configuration (FIG. #18), which is characterized because it already has the check integrated (FIG. #12), this module has a gasket (47) and a nut (48) to secure it to the inferior part of the tank. The tank (45) at the same time has a bushing connection (49), said connection (49) in its exterior parts connects with the conduit (29) the module of release double action (FIG. #11), at the same time the conduit (28) connects the feeding line. The interior part of the bushing connection (49) connects with the conduit (50) of the module of closing and opening.

Functioning of Configuration #3—For Opening and Closing of a Pressurized Tank that Contains Fluids Susceptible to Compression

The fluid enters the system through the conduit (28) of the module of release double action, and exits the module by the conduit (29) towards the exterior part of the connection bushing (49), the interior part of this bushing connection (49) is connected to the conduit (50) of the module of closing and opening for this configuration, the fluid enters trough this connection (50) provoking the piston (60) with its gasket (61) to position itself over the tube (52) with this action closing the tank (45), act that follows the check (FIG. #12) due to the pressure of the fluid it passes to the open position (FIG. #19a), allowing the entrance of the fluid to the tank. Once the pressure of the fluid in the tanks equilibrates with the feeding pressure, the check (FIG. #12) passes to the closed position, as illustrated in FIG. #19b. At this moment the fluid finds itself pressurized in the tank (45) and has contact with the inferior part of the piston (60), however, the system is maintained in closed position, because we have a closing vector, since the piston (60) has a transversal area greater than the of the transversal area of the tube (52).

If we take the force formula=pressure×area, we have that the resulting vector is closed, since we have:
A=Transversal area of the piston (60)
a=Transversal area of the tube (52)
P=Existing pressure of the fluid

Therefore; the resulting vector at this point is the following;
(5) Resulting Vector=P(A)−P (A-a); that results in a positive vector, that is of closing.

Once the module of release double action is put to action pushing the nut-bolt (42) we provoke the termination conical (32) to close the orifice (27) and to open an exit to the atmosphere trough the slots (26) passing the fluid to the space (10) in between the spike (33) and the orifice (35), the resulting fluid from the depressure is left in the cavity (39) to be conducted through the conduit (40) towards the discharge. Once depressurized the superior part of the module of closing and opening, the existing pressure in the tank (45) pushes the piston (60) to an opening position allowing the contents of the tank (45) to be discharged trough the tube (52) and its continuation (53) to the exterior. This is due because in this moment we have a vector of opening, due to the following formula;
Force=pressure×area, we have that the resulting vector is opened, because we have
A=Transversal area of the piston (60)
A=Transversal area of the tube (52)

(20) P=Existing pressure of the fluid

Therefore, the resulting vector in this point is the following;

Resulting Vector=P(A)−P (A−a); in which the pressure of the superior part of the piston (60) is zero, therefore the result would be;

Resulting vector=[−P (A−a)]; being this a negative vector, or being a vector of opening.

During the moment we stop the action of the module of release double action, as was explained before, the piston (60) and its gasket (61) will close over the tube (52) detaining the flow towards the exterior.

For better clarity in representing the units of the invention of this system of opening and closing for pressurized fluids, the following analogies are indicated.

In the 3 configurations 3 modules are presented which are;

The module of closing and opening, the module of release double action and the module of flow resistance, system check, it is important to point out the configuration 1 and 2 are identical, with the difference being that the module of closing and opening manages the closing in favor of the flow (configuration #2) and in the other configuration the closing is managed contra-flow (configuration #1).

Configuration #3 is an adaptation of configuration 2 (closing in favor of flow) in which the 3 modules are found in force, the module of release double action located in the exterior of the tank (45) and an integration of the check (FIG. #12) inside the (20) module of closing and opening, this module additional to the check, has a piston (60) that is equivalent to the piston (3), and is displaced trough an interior diameter (59) equivalent to the interior diameter (2), an entrance connection in the superior part (50) equivalent to the entrance connection (10), we have in the inferior part of the tube that peeks out of the bottom (52) equivalent to the tube (5), the studs (54) and nuts (55) are utilized to join both structures (inferior and superior) allowing the communication of the pressurized fluid with the inferior part of the piston (60). As for the function of the check, its position allows that in the first instance the fluid that enters the module of closing and opening, to push the piston towards a closed position, when the pressure beats the spring of the check and passes to the open position, it allows the tank to fill, by doing so and by the appropriate configuration of the module allows the pressure of the fluid to exercise force in the inferior part of the piston, which is the same as occurs in configuration #2.

Having sufficiently described my invention, I consider this a novelty and therefore claim as my exclusive property, the content in the following clauses.

1) System for opening and closing for pressurized fluids characterized because it is constituted by 3 modules; a) module of closing and opening, b) module of flow resistance, c) module of release double action, which are found interconnected, which interconnection is in diverse configurations, a) the module of closing and opening consists of a body of an open valve in one of its extremes with an interior diameter along itself, by which the piston is displaced, said piston integrates its inferior part a sealed element that allows the closing over a tube, said tube peeks out from the bottom of the interior body of the valve and its exterior diameter is less than the interior diameter of the body of the valve, said tube communicates with the exterior of the valve trough an inferior connection, in between the interior bottom of the valve and the superior border of the tube, the conduit is situated perpendicular to the interior diameter which communicates with the exterior of the body of the valve, the superior part of the boy of the valve is sealed by a lid, which has a conduit in the superior part towards the exterior of the valve, b) module of flow resistance (system check) which consist of a body of a valve open by both extremes with an interior diameter along, in which in determined point in its extremes said diameter is reduced, acting like a stop to position a check element, allowing that the path of the fluid be unidirectional, the body of the valve is sealed by two lids located in its extremes, which have a conduit, one of the conduits is of entrance and the other is of exit of the fluids, in between the point where the element check and the entrance conduit are positioned perpendicularly located is a conduit that communicates the interior diameter of the body of the valve with the exterior, c) module of release double action consists of a valve body open in one of its extremes that has an interior diameter, which has longitude slots along the same, at the bottom of this interior diameter a concentric orifice is located that communicates with the entrance conduit. In the inferior part of the valve body a conduit is placed perpendicular that communicates the interior of this body, with the exterior, inside this interior diameter a piston is allocated that in its inferior part has a conical termination which its size allows the closing of the central orifice located in the bottom of the body of the valve, in the superior part the piston has a spike which couples a seal element to close the central orifice that possess the lid by which the body of the valve is to be sealed, said central orifice has a transversal area greater than the transversal area of the spike allowing the passage of fluid that resulted from the de-pressure, said spike in its superior part has a threaded termination, the lid is extended forming a cavity that recollects the fluids resulting from the de-pressure, said cavity has a conduit of drain, a spring of compression is coupled to the spike using a nut-bolt to retain the spring, said nut-bolt is a cylinder structure open from one of its extremes, which is the bolt of drive, which is left immersed in that cavity of containment with its open part towards inside forming a closed deposit, in the external perimeter of the nut bolt a slot is placed to accommodate an o-ring gasket that allows better sealing between the containment cavity and the nut and bolt.

2) System of opening and closing for pressurized fluids, according to claim 1, characterized by configuration 1, consists of a module of flow resistance, which its entrance connection, is the feeding point of the system, its exit connection connects with the inferior conduit of the module of closing and opening, its perpendicular conduit connects with the entrance conduit of the module of release double action, at the same time the perpendicular conduit of the module of release double action connects with the superior conduit of the module of closing and opening, lastly the perpendicular conduit of the module of closing and opening is the exit of the system.

3) System of opening and closing for pressurized fluids, according to claim 1, characterized by configuration 2, consists of a module of flow resistance which its entrance conduit is the entering conduit of the fluid to the system, its exit conduit connects with the perpendicular conduit of the closing and opening, the perpendicular conduit connects with the conduit entrance of the module of release double action, the perpendicular conduit of the module of release double action connects with the superior conduit of the module of closing and opening, lastly the inferior conduit of the module of closing and opening is the exit of the system.

4) System of opening and closing for pressurized fluids according to claim 1, Characterized because by utilizing it for the discharge of a tank that contains pressurized fluids susceptible to compression the module of resistance flow (check element) is integrated to the module of closing and opening, once integrated they are accommodated in the inferior part of the tank, said tanks has a bushings connection, at the bottom of the discharge tube that peeks out of the bottom of the tank, meanwhile the module of release double action is placed in the exterior of the tank.

5) System of opening and closing for pressurized fluids according to claim 1,4, characterized by the integration of the module of resistance low (check element) and the module of closing and opening are constituted by cylinder structure opened on one side that has an interior diameter alongside that is positioned with the open part towards the bottom, over the discharge tube of the tank, through an open structure, in the interior of this cylinder structure another structure is accommodated opened on one side of less size with an open side towards the inside of the major cylinder structure, whose exterior diameter moves by the interior diameter of the major cylinder structure, the smaller cylinder structure, comes to be the piston of the module, in the inferior part of it, a sealing element is integrated that seals against the discharge tube of the tank, in the superior part or roof of the larger sized cylinder structure an orifice is placed that communicates with the interior of the same to position a check that will allows the fluid to only be able to exit from the interior of the structure towards the tank and not vice versa, in the roof of this same larger sized structure a conduit is placed that connects the interior part of the connection bushings of the tank, at the same time the exterior part of the connection bushings connects with the perpendicular conduit of the module of release double action, the conduit of entrance of the module of release double action, comes to be the entrance of the fluid to the system.

6) Check structure characterized in that it contains a tubular bolt with a interior diameter which has an superior extreme with a head, the interior diameter of the tubular bolt extends until it reaches said head, over the tubular bolt and when coming across he head a sealant element is positioned, under this element and over the perimeter of the tubular bolt at least one orifice is places that allows the maintenance of the flow area constant that has the transversal area interior of the tubular bolt, the tubular bolt is introduced in an orifice trough which a fluid passes and is obstructed, the exterior diameter of the tubular bolt is displaced through the diameter of the orifice to be clogged, a spring of compression that can be situated over the head of this check element or can be in another extreme of the orifice when positioned to clog in the exterior diameter of the tubular bolt and subject with a element of retention, that acts overs this check element to seal said orifice through the head and the sealant element, this check element permits the unidirectional passage of the fluid, in its open position the fluid passes through the interior diameter of the tubular bolt and moves towards the other side of the orifice to obstruct trough the orifices located in the perimeter of the tubular bolt, the open position of this check element occurs when the pressure of the fluid in the side of the orifice when clogging wherein the tubular bolt is located is greater than the pressure that exists on the other side of the orifice when clogging were the head is found, this difference of pressures is sufficiently large enough that it permits beating the spring of compression.

7) Structure check in accordance to claim 6, characterized in that under the element of retention is coupled directly with the tubular structure, is allocated through a washer.

8) Structure check in accordance to claim 6, characterized because in said tubular structure can be subjected trough diverse mediums of containment.

9) Structure check in accordance to claim 6, characterized because in configuration 3 the system of closing and opening is integrated to the system and forms only one structure.

10) Structure check in accordance to claim 9, characterized because in said configuration the tubular structure check does not contain the cutouts nor the supporting beams.

11) Structure check in accordance to claim 9, characterized because in said configuration the tubular structure check is integrated with an orifice in its inferior perimeter to accommodate a bolt which acts as a lock.
